(19) United States
(12) Patent Application Publication
(10) Pub. No.: US 2025/0267653 A1
(43) Pub. Date: Aug. 21, 2025

(54) DELAY-AWARE LCP ENHANCEMENTS

(71) Applicant: QUALCOMM Incorporated, San Diego, CA (US)

(72) Inventors: Linhai HE, San Diego, CA (US); Diana MAAMARI, San Diego, CA (US)

(21) Appl. No.: 19/053,368

(22) Filed: Feb. 13, 2025

Related U.S. Application Data
(60) Provisional application No. 63/555,690, filed on Feb. 20, 2024.

(51) Int. Cl. H04W 72/1268; H04W 28/06

(52) U.S. Cl. CPC H04W 72/1268; H04W 28/06

(57) ABSTRACT

Method and apparatus for an enhanced delay-aware logical channel procedure. The apparatus identifies a first remaining time of a first discard timer associated with a first delay budget for at least a first PDU that falls below a threshold for an associated first LCH. The apparatus adjusts an LCH priority for the at least the first PDU in response to the remaining time falling below the threshold based at least on a second remaining time of a second discard timer associated with a second delay budget of a target LCH having a next higher priority than the first LCH. The apparatus transmits an uplink transmission based on an adjusted LCH priority for the at least the first PDU.

### CROSS REFERENCE TO RELATED APPLICATION(S)

This application claims the benefit of and priority to U.S. Provisional Application Ser. No. 63/555,690, entitled “DELAY-AWARE LCP ENHANCEMENTS” and filed on Feb. 20, 2024, which is expressly incorporated by reference herein in its entirety.

### TECHNICAL FIELD

The present disclosure relates generally to communication systems, and more particularly, to a configuration for an enhanced delay-aware logical channel procedure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus identifies a first remaining time of a first discard timer associated with a first delay budget for at least a first protocol data unit (PDU) that falls below a threshold for an associated first logical channel (LCH). The apparatus adjusts an LCH priority for the at least the first PDU in response to the remaining time falling below the threshold based at least on a second remaining time of a second discard timer associated with a second delay budget of a target LCH having a next higher priority than the first LCH. The apparatus transmitting an uplink transmission based on an adjusted LCH priority for the at least the first PDU.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a LCH priority procedure.

FIG. 5 is a call flow diagram of signaling between a UE and a network entity.

FIG. 6 is a flowchart of a method of wireless communication.

FIG. 7 is a flowchart of a method of wireless communication.

FIG. 8 is a diagram illustrating an example of a hardware implementation for an example apparatus and/or network entity.

FIG. 9A illustrates an example of XR traffic for wireless communication, in accordance with various aspects of the present disclosure.

FIG. 9B illustrates an example of a UE exchanging XR traffic with an XR service or cloud gaming service, in accordance with various aspects of the present disclosure.

### DETAILED DESCRIPTION

In wireless communications, logical channel prioritization (LCP) is a procedure applied by the UE to multiplex data from different logical channels into an uplink transport block. A UE may be configured with multiple logical channels and each logical channel (LCH) may carry different types of traffic. The network may schedule an uplink grant or uplink transport block one at a time, but the network may not specify or assign a LCH for the transport block. In instances where multiple LCHs have data and there is one uplink transport block, the UE can be informed of the manner of multiplexing data from different LCHs into the transport block.

The LCP procedure may determine the order of the LCHs during the multiplexing based on their priority and leaky-bucket regulators configured by the network. The amount of data from an LCH that can be scheduled within a unit of time may be controlled or determined by a leaky bucket regulator, which helps to provide a smoothing mechanism for bursty traffic to enable transmission of a steady flow of traffic in a wireless network. The number of “tokens” in a regulator (Bj) may be added continuously but removed whenever data from the LCH is removed. An LCH may be considered in the LCP procedure only if its Bj is positive. The UE starts the LCP procedure from the LCH with the highest priority, if Bj of the current LCH is positive, data can be scheduled from this LCH. Otherwise, the UE moves on to the LCH with the second highest priority, and so on. The LCH priority may be configured via RRC signaling and may be static. For traffic with a delay deadline, the remaining time of a PDU may need to be considered in LCP procedure. For example, a network entity may be temporarily short in uplink resources, such that data from the highest LCH is scheduled most of the time, and the data in other LCHs may be approaching their delivery deadlines. In such instances, it is beneficial to temporarily change the priority order of the LCHs and schedule data with the least remaining time first, even if they are not from the LCH with the highest priority.

Aspects presented herein provide a configuration for an enhanced delay-aware logical channel procedure, such that the priority order of an LCHs is changed to a higher priority. At least one advantage of the disclosure is that adjusting the priority of LCHs may improve the latency performance of lower priority traffic.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

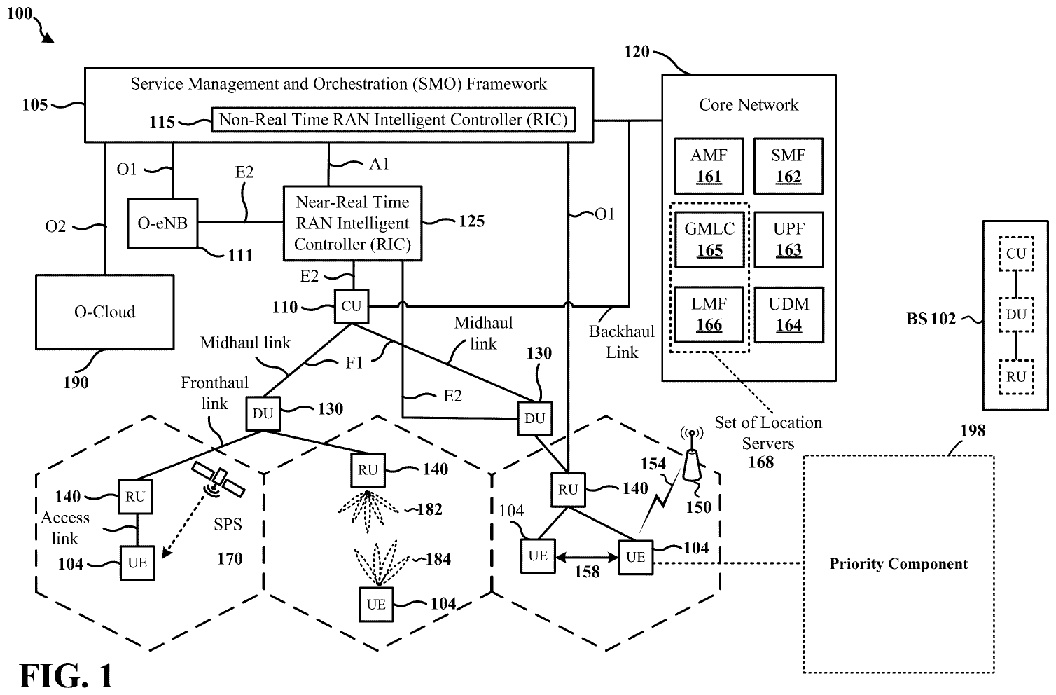

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a priority component 198 that may be configured to identify a first remaining time of a first discard timer associated with a first delay budget for at least a first PDU that falls below a threshold for an associated first LCH; adjust an LCH priority for the at least the first PDU in response to the remaining time falling below the threshold based at least on a second remaining time of a second discard timer associated with a second delay budget of a target LCH having a next higher priority than the first LCH; and transmit an uplink transmission based on an adjusted LCH priority for the at least the first PDU.

Although the following description may be focused on 5G NR, the concepts described herein may be applicable to other similar areas, such as LTE, LTE-A, CDMA, GSM, and other wireless technologies.

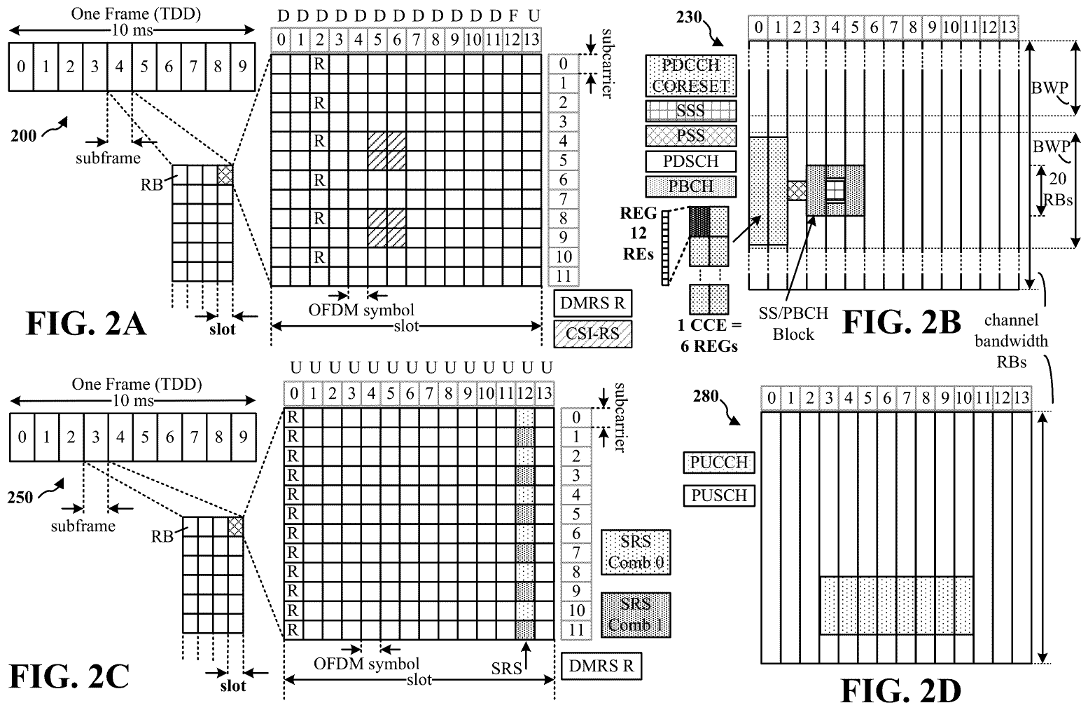

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where γ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

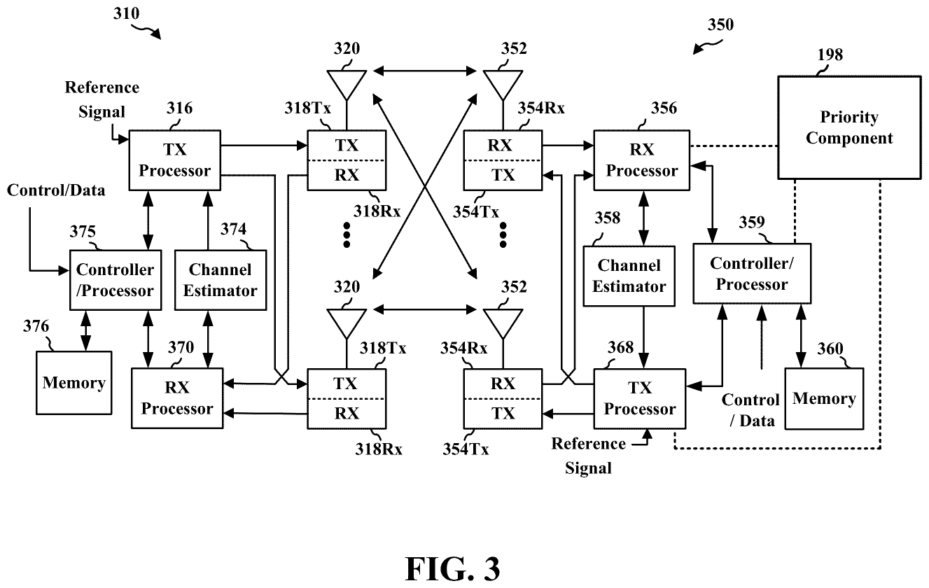

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the priority component 198 of FIG. 1.

In wireless communications, LCP is a procedure applied by the UE to multiplex data from different logical channels into an uplink transport block. A UE may be configured with multiple logical channels and each LCH may carry different types of traffic (e.g., voice, video traffic). The network may schedule an uplink grant or uplink transport block one at a time, but the network may not specify or assign a LCH for the transport block. In instances where multiple LCHs have data and there is one uplink transport block, the UE can be informed of the manner of multiplexing data from different LCHs into the transport block.

The LCP procedure may be applied whenever a new transmission is performed. The LCP procedure may determine the order of the LCHs during the multiplexing based on their priority and using regulators based on parameter(s) configured by the network. The amount of data from an LCH that can be scheduled within a unit of time may be controlled or determined by such regulators, which may be referred to as a leaky bucket regulator. A variable Bj may be maintained for each logical channel j. The MAC entity may initialize Bj of the logical channel to zero when the logical channel is established. The number of “tokens” in a regulator may be added continuously and removed whenever data from the LCH is removed As an example, for each logical channelj, the MAC entity may increment Bj by the product PBR×T before every instance of the LCP procedure, where T is the time elapsed since Bj was last incremented. If the value of Bj is greater than the bucket size (i.e. PBR×BSD), the MAC entity may set Bj to the bucket size. When a new transmission is performed, the MAC entity may allocate resources to the selected logical channel and decrement Bj by the total size of MAC SDUs served to logical channel j. If resources remain, logical channels can be selected or served in a decreasing priority order (e.g., regardless of the value of Bj) until either the data for that logical channel or the UL grant is exhausted, whichever comes first. The value of Bj can be negative. An LCH may be considered in the LCP procedure only if its Bj is positive, e.g., Bj>0. The UE starts the LCP procedure from the LCH with the highest priority, if Bj of the current LCH is positive, data can be scheduled from this LCH. Otherwise, the UE moves on to the LCH with the second highest priority, and so on. The LCH priority may be configured via RRC signaling and may be static. For traffic with a delay deadline, the remaining time of a PDU may need to be considered in LCP procedure. For example, a network entity may be temporarily short in uplink resources (e.g. due to congestion), such that data from the highest LCH is scheduled most of the time, and the data in other LCHs may be approaching their delivery deadlines. In such instances, it is beneficial to temporarily change the priority order of the LCHs and schedule data with the least remaining time first, even if they are not from the LCH with the highest priority.

Aspects presented herein provide a configuration for an enhanced delay-aware logical channel procedure, such that the priority order of an LCHs is changed to a higher priority. For example, the UE may adjust the priority of an LCH based on time sensitive data. At least one advantage of the disclosure is that adjusting the priority of LCHs may improve the latency performance of lower priority traffic.

In some instances, upon receipt of an uplink grant, a UE may determine whether a remaining time of a PDU drops below a triggering threshold for an associated LCH. In such instances, the remaining time of the PDU may correspond to a residual value of the associated packet data convergence protocol (PDCP) discard timer. The triggering threshold may be configured via RRC signaling for an LCH that is eligible or configured for dynamic priority. If the remaining time of the PDU drops below the triggering threshold for its associated LCH, the LCH may be eligible for a higher LCH priority when considered in the LCP procedure. In some instances, the network may configure a limit on the highest priority level that an LCH may upgrade to. For example, an LCH with priority level 4 may not increase its priority beyond priority level 2. The network may configure the limit to be one or more levels above the current level and is not intended to be limited to the examples disclosed herein.

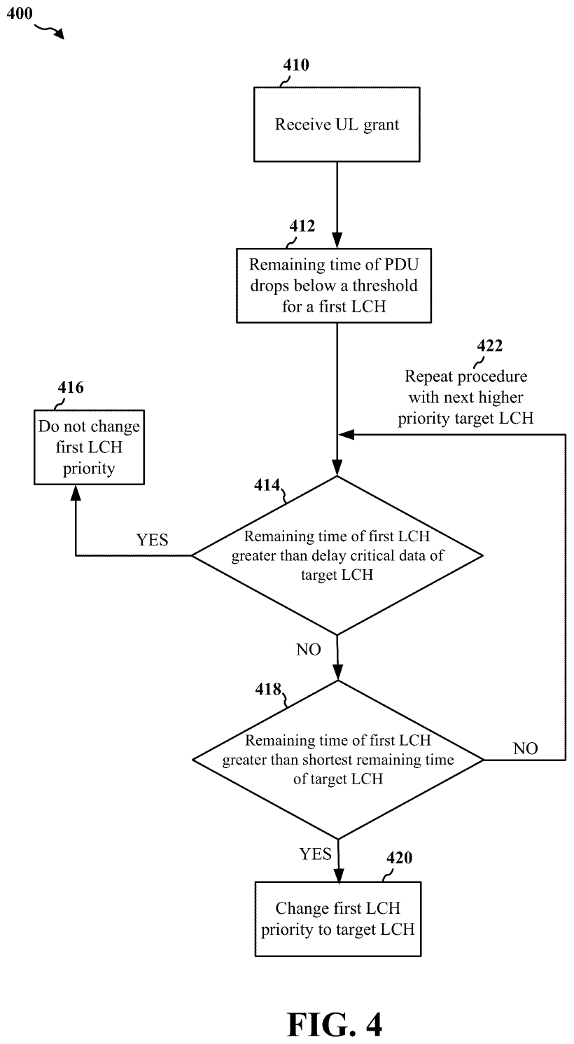

FIG. 4 illustrates a diagram 400 of the LCH priority procedure. A UE may perform the LCH priority procedure after receiving an uplink grant 410. At 412, the UE may determine if the remaining time of the PDU drops below the triggering threshold for its associated LCH, the LCH may be eligible for a higher LCH priority. The procedure to adjust or increase a first LCH priority for a PDU may include starting with the LCH having the next level of priority that is higher than the current level of priority for the first LCH. The LCH having the next level of priority that is higher than the priority of the first LCH may be referred to as a target LCH. At 414, the UE may determine whether the remaining time of the first LCH is greater than the any delay critical data of the target LCH. The delay critical data in an LCH may include a set of PDUs whose remaining time is below the DSR triggering threshold. In some instances, the triggering threshold may be a threshold configured by the network. At 416, if the remaining time of the target LCH is greater or longer than any delay-critical data of the target LCH, then the procedure stops and the priority of the first LCH is not changed. At 418, the UE may determine whether the remaining time of the first LCH is greater than or longer than the shortest remaining time of the target LCH. At 420, if the remaining time of the first LCH is greater than or longer than the shortest remaining time of the target LCH, then the procedure stops and the priority of the first LCH is set to the priority of the target LCH. If the conditions of 414 and 418 are not satisfied, then the PDU associated with the first LCH has a remaining time that is less than or shorter than the shortest remaining time of the target LCH, such that the PCU associated with the first LCH is even more urgent. As such, at 422, the procedure may repeat with a new target LCH having the next level priority than the original target LCH. In some aspects, the procedure may repeat until a final target LCH is determined, or the priority limit has been reached. As mentioned herein, in some aspects, the priority limit may be configured via RRC.

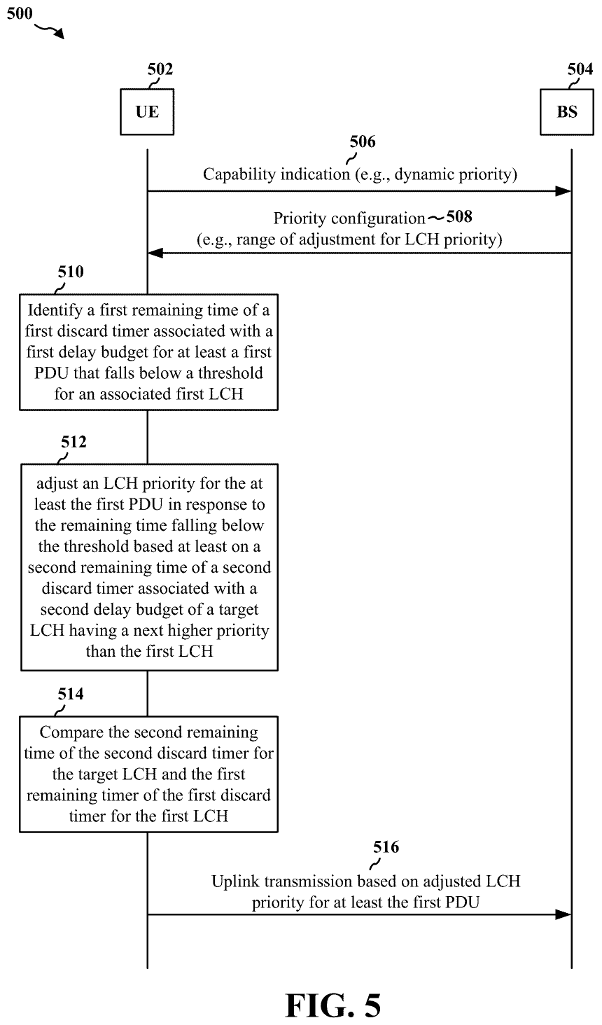

FIG. 5 is a call flow diagram 500 of signaling between a UE 502 and a base station 504. The base station 504 may be configured to provide at least one cell. The UE 502 may be configured to communicate with the base station 504. For example, in the context of FIG. 1, the base station 504 may correspond to base station 102 and the UE 502 may correspond to at least UE 104. In another example, in the context of FIG. 3, the base station 504 may correspond to base station 310 and the UE 502 may correspond to UE 350.

At 506, the UE 502 may transmit a capability indication to the base station 504. The base station 504 may obtain the capability indication from the UE 502. In some aspects, the capability indication may indicate an amount of LCHs that are configured with a dynamic priority. For example, the capability indication may indicate a maximum number of LCHs that may be configured with dynamic priority. In some aspects, the capability indication may indicate an amount of target LCHs to which an LCH may upgrade to. For example, the capability indication may indicate a maximum number of target LCHs that the LCH may upgrade or switch priorities.

At 508, the base station 504 may provide a priority configuration to the UE 502. The UE 502 may receive the priority configuration from the base station 504. The priority configuration may indicate a range of adjustment of LCH priority. For example, the priority configuration may indicate a limit or range of a target LCH for each LCH configured with or eligible for dynamic priority.

At 510, the UE 502 may identify a first remaining time of a first discard timer associated with a first delay budget. The UE 502 may identify the first remaining time of the first discard timer associated with the first delay budget for at least a first PDU that falls below a threshold for an associated first LCH. In some aspects, the threshold may be configured via RRC signaling for the first LCH. The first LCH may be configured with a dynamic priority.

At 512, the UE 502 may adjust an LCH priority for the at least the first PDU. The UE 502 may adjust the LCH priority for the at least the first PDU in response to the remaining time falling below the threshold. The UE may adjust the LCH priority for the at least the first PDU in response to the remaining time falling below the threshold based at least on a second remaining time of a second discard timer associated with a second delay budget of a target LCH having a next higher priority than the first LCH.

At 514, to adjust the LCH priority, the UE 502 may compare the second remaining time of the second discard timer for the target LCH and the first remaining time of the first discard timer for the first LCH. In some aspects, the LCH priority for at least the first PDU may not be adjusted in response to the first remaining time of the first discard timer for the first LCH being greater than the second remaining time of the second discard timer for the target LCH. In some aspects, the LCH priority for at least the first PDU may be adjusted in response to the first remaining time of the first discard timer for the first LCH being greater than a shortest remaining time of the second discard timer of the target LCH. In such instances, the LCH priority for at least the first PDU may be adjusted to the priority of the target LCH.

At 516, the UE 502 may transmit an uplink transmission to the base station 504. The base station 504 may obtain the uplink transmission from the UE 502. The UE 502 may transmit the uplink transmission based on an adjusted LCH priority for the at least the first PDU.

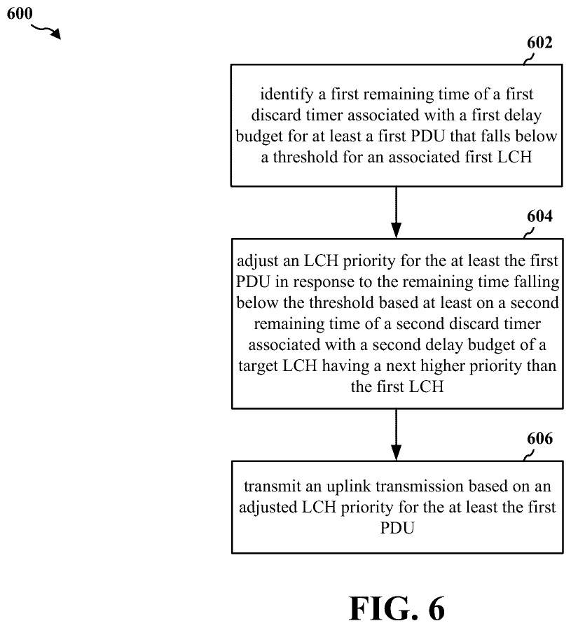

FIG. 6 is a flowchart 600 of a method of wireless communication. The method may be performed by a UE (e.g., the UE 104; the apparatus 804). One or more of the illustrated operations may be omitted, transposed, or contemporaneous. The method may allow a UE to adjust an LCH priority for a PDU.

At 602, the UE may identify a first remaining time of a first discard timer associated with a first delay budget. For example, 602 may be performed by priority component 198 of apparatus 804. The UE 502 may identify (e.g., at 510 or 412) the first remaining time of the first discard timer associated with the first delay budget for at least a first PDU that falls below a threshold for an associated first LCH. In some aspects, the threshold may be configured via RRC signaling for the first LCH. The first LCH may be configured with a dynamic priority.

At 604, the UE may adjust an LCH priority for the at least the first PDU. For example, 604 may be performed by priority component 198 of apparatus 804. The UE 502 may adjust (e.g., at 512 or 420) the LCH priority for the at least the first PDU in response to the remaining time falling below the threshold. The UE may adjust the LCH priority for the at least the first PDU in response to the remaining time falling below the threshold based at least on a second remaining time of a second discard timer associated with a second delay budget of a target LCH having a next higher priority than the first LCH.

At 606, the UE may transmit an uplink transmission. For example, 606 may be performed by priority component 198 of apparatus 804. The UE 502 may transmit the uplink transmission (e.g., 516) based on an adjusted LCH priority for the at least the first PDU.

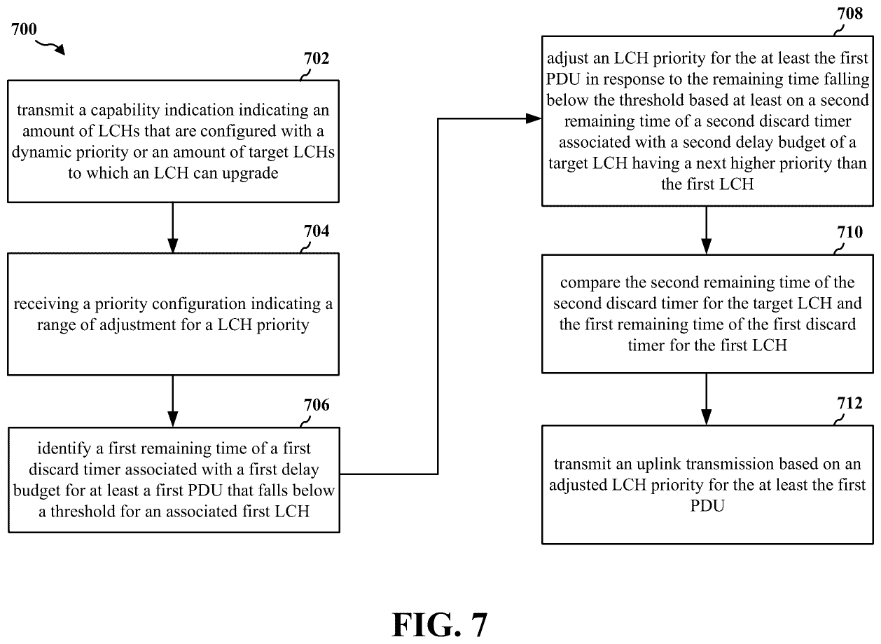

FIG. 7 is a flowchart 700 of a method of wireless communication. The method may be performed by a UE (e.g., the UE 104; the apparatus 804). One or more of the illustrated operations may be omitted, transposed, or contemporaneous. The method may allow a UE to adjust an LCH priority for a PDU.

At 702, the UE may transmit a capability indication. For example, 702 may be performed by priority component 198 of apparatus 804. In some aspects, the UE 502 may transmit a capability indication (e.g., 506). In some aspects, the capability indication may indicate an amount of LCHs that are configured with a dynamic priority. For example, the capability indication (e.g., 506) may indicate a maximum number of LCHs that may be configured with dynamic priority. In some aspects, the capability indication (e.g., 506) may indicate an amount of target LCHs to which an LCH may upgrade to. For example, the capability indication may indicate a maximum number of target LCHs that the LCH may upgrade or switch priorities.

At 704, the UE may receive a priority configuration. For example, 704 may be performed by priority component 198 of apparatus 804. In some aspects, the UE 502 may receive a priority configuration 508. The priority configuration may indicate a range of adjustment of LCH priority. For example, the priority configuration may indicate a limit or range of a target LCH for each LCH configured with or eligible for dynamic priority.

At 706, the UE may identify a first remaining time of a first discard timer associated with a first delay budget. For example, 706 may be performed by priority component 198 of apparatus 804. The UE 502 may identify (e.g., 510 or 412) the first remaining time of the first discard timer associated with the first delay budget for at least a first PDU that falls below a threshold for an associated first LCH. In some aspects, the threshold may be configured via RRC signaling for the first LCH. The first LCH may be configured with a dynamic priority.

At 708, the UE may adjust an LCH priority for the at least the first PDU. For example, 708 may be performed by priority component 198 of apparatus 804. The UE may adjust (e.g., 512 or 420) the LCH priority for the at least the first PDU in response to the remaining time falling below the threshold. The UE may adjust the LCH priority for the at least the first PDU in response to the remaining time falling below the threshold based at least on a second remaining time of a second discard timer associated with a second delay budget of a target LCH having a next higher priority than the first LCH.

At 710, to adjust the LCH priority, the UE may compare (e.g., 414 or 418) the second remaining time of the second discard timer for the target LCH and the first remaining time of the first discard timer for the first LCH. For example, 710 may be performed by priority component 198 of apparatus 804. In some aspects, the LCH priority for at least the first PDU may not be adjusted in response to (e.g., at 416) the first remaining time of the first discard timer for the first LCH being greater than the second remaining time of the second discard timer for the target LCH. In some aspects, the LCH priority for at least the first PDU may be adjusted (e.g., at 420) in response to the first remaining time of the first discard timer for the first LCH being greater than a shortest remaining time of the second discard timer of the target LCH. In such instances, the LCH priority for at least the first PDU may be adjusted to the priority of the target LCH.

At 712, the UE may transmit an uplink transmission. For example, 712 may be performed by priority component 198 of apparatus 804. In some aspects, the UE 502 may transmit an uplink transmission (e.g., 516). The UE may transmit the uplink transmission based on an adjusted LCH priority for the at least the first PDU.

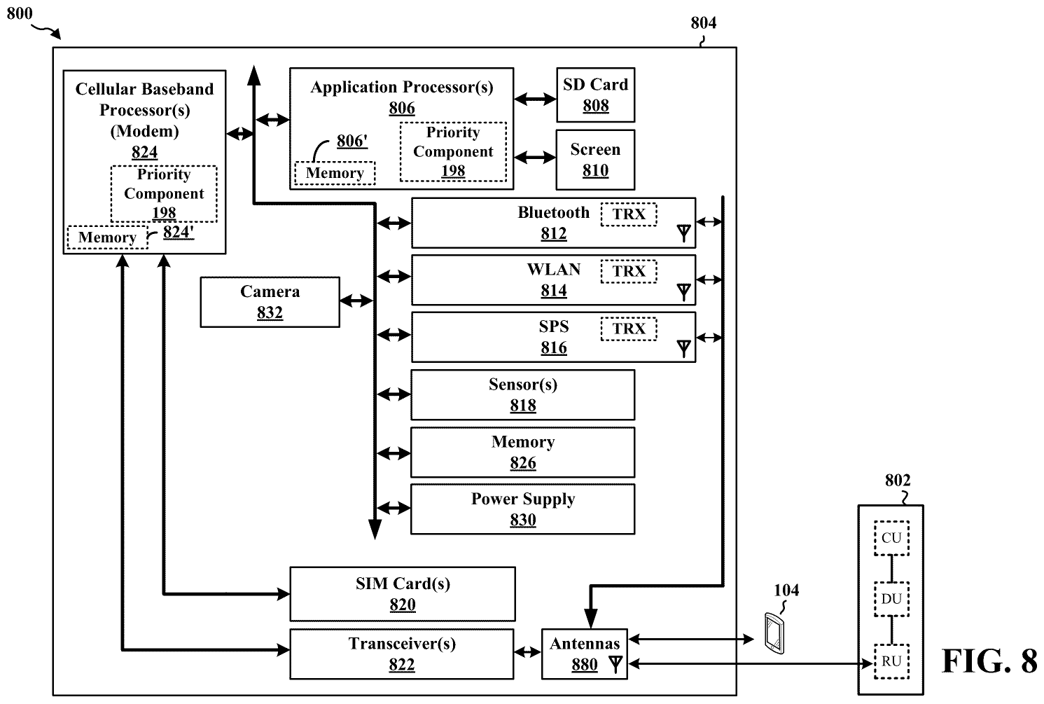

FIG. 8 is a diagram 800 illustrating an example of a hardware implementation for an apparatus 804. The apparatus 804 may be a UE, a component of a UE, or may implement UE functionality. In some aspects, the apparatus 804 may include at least one cellular baseband processor 824 (also referred to as a modem) coupled to one or more transceivers 822 (e.g., cellular RF transceiver). The cellular baseband processor(s) 824 may include at least one on-chip memory 824′. In some aspects, the apparatus 804 may further include one or more subscriber identity modules (SIM) cards 820 and at least one application processor 806 coupled to a secure digital (SD) card 808 and a screen 810. The application processor(s) 806 may include on-chip memory 806′. In some aspects, the apparatus 804 may further include a Bluetooth module 812, a WLAN module 814, an SPS module 816 (e.g., GNSS module), one or more sensor modules 818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 826, a power supply 830, and/or a camera 832. The Bluetooth module 812, the WLAN module 814, and the SPS module 816 may include an on-chip transceiver (TRX) (or in some cases, just a receiver (RX)). The Bluetooth module 812, the WLAN module 814, and the SPS module 816 may include their own dedicated antennas and/or utilize the antennas 880 for communication. The cellular baseband processor(s) 824 communicates through the transceiver(s) 822 via one or more antennas 880 with the UE 104 and/or with an RU associated with a network entity 802. The cellular baseband processor(s) 824 and the application processor(s) 806 may each include a computer-readable medium/memory 824′, 806′, respectively. The additional memory modules 826 may also be considered a computer-readable medium/memory. Each computer-readable medium/memory 824′, 806′, 826 may be non-transitory. The cellular baseband processor(s) 824 and the application processor(s) 806 are each responsible for general processing, including the execution of software stored on the computer-readable medium/memory. The software, when executed by the cellular baseband processor(s) 824/application processor(s) 806, causes the cellular baseband processor(s) 824/application processor(s) 806 to perform the various functions described supra. The cellular baseband processor(s) 824 and the application processor(s) 806 are configured to perform the various functions described supra based at least in part of the information stored in the memory. That is, the cellular baseband processor(s) 824 and the application processor(s) 806 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 824/application processor(s) 806 when executing software. The cellular baseband processor(s) 824/application processor(s) 806 may be a component of the UE 350 and may include the at least one memory 360 and/or at least one of the TX processor 368, the RX processor 356, and the controller/processor 359. In one configuration, the apparatus 804 may be at least one processor chip (modem and/or application) and include just the cellular baseband processor(s) 824 and/or the application processor(s) 806, and in another configuration, the apparatus 804 may be the entire UE (e.g., see UE 350 of FIG. 3) and include the additional modules of the apparatus 804.

As discussed supra, the component 198 may be configured to identify a first remaining time of a first discard timer associated with a first delay budget for at least a first PDU that falls below a threshold for an associated first LCH; adjust an LCH priority for the at least the first PDU in response to the remaining time falling below the threshold based at least on a second remaining time of a second discard timer associated with a second delay budget of a target LCH having a next higher priority than the first LCH; and transmit an uplink transmission based on an adjusted LCH priority for the at least the first PDU. The component 198 may be within the cellular baseband processor(s) 824, the application processor(s) 806, or both the cellular baseband processor(s) 824 and the application processor(s) 806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 804 may include a variety of components configured for various functions. In one configuration, the apparatus 804, and in particular the cellular baseband processor(s) 824 and/or the application processor(s) 806, may include means for identifying a first remaining time of a first discard timer associated with a first delay budget for at least a first PDU that falls below a threshold for an associated first LCH. The apparatus includes means for adjusting an LCH priority for the at least the first PDU in response to the remaining time falling below the threshold based at least on a second remaining time of a second discard timer associated with a second delay budget of a target LCH having a next higher priority than the first LCH. The apparatus includes means for transmitting an uplink transmission based on an adjusted LCH priority for the at least the first PDU. The apparatus further includes means for comparing the second remaining time of the second discard timer for the target LCH and the first remaining time of the first discard timer for the first LCH. The apparatus further includes means for receiving a priority configuration indicating a range of adjustment for the LCH priority. The apparatus further includes means for transmitting a capability indication indicating an amount of LCHs that are configured with a dynamic priority or an amount of target LCHs to which an LCH can upgrade. The means may be the component 198 of the apparatus 804 configured to perform the functions recited by the means. As described supra, the apparatus 804 may include the TX processor 368, the RX processor 356, and the controller/processor 359. As such, in one configuration, the means may be the TX processor 368, the RX processor 356, and/or the controller/processor 359 configured to perform the functions recited by the means.

A wireless communication network may support various types of wireless traffic. For example, the uplink data transmission (e.g., 516), or described in connection with any of FIGS. 4-8 may include XR traffic. As an example of one type of traffic, XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst.

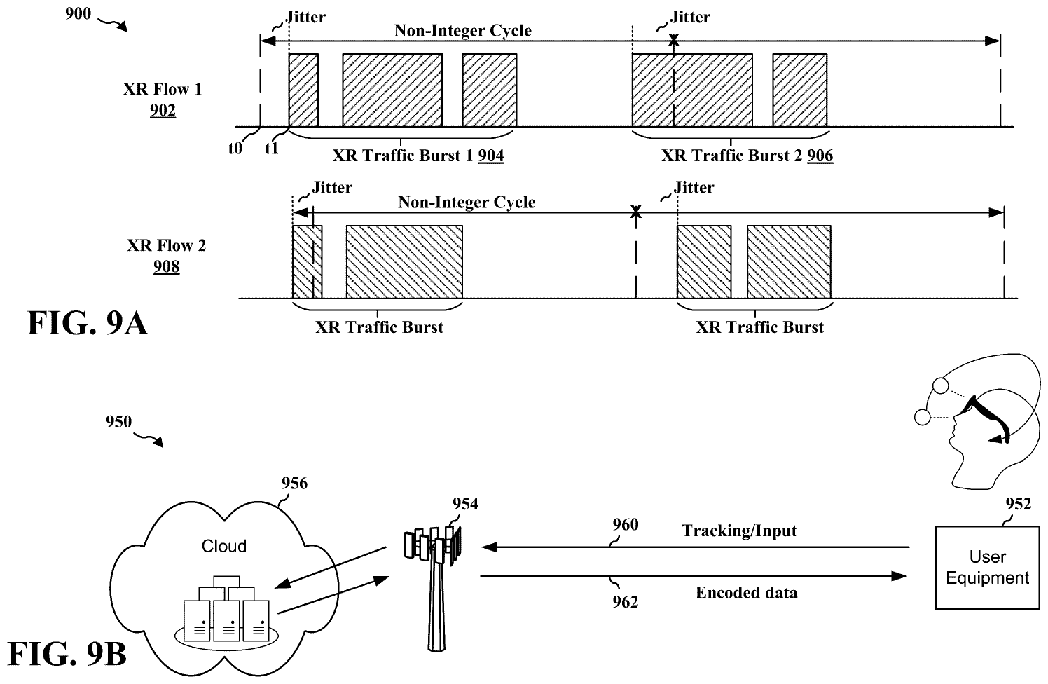

FIG. 9A illustrates an example of XR traffic for wireless communication, in accordance with various aspects of the present disclosure. The diagram 900 illustrates a first XR flow 902 that includes a first XR traffic burst 904 and a second XR traffic burst 906. As illustrated in the diagram 900, the traffic bursts may include different numbers of packets, e.g., the first XR traffic burst 904 being shown with three packets (represented as rectangles in the diagram 900) and the second XR traffic burst 906 being shown with two packets. Furthermore, as illustrated in the diagram 900, the three packets in the first XR traffic burst 904 and the two packets in the second XR traffic burst 906 may vary in size, that is, packets within the first XR traffic burst 904 and the second XR traffic burst 906 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 902, a UE may expect a first packet of the first XR traffic burst 904 to arrive at time t0, but the first packet of the first XR traffic burst 904 arrives at time t1.

XR traffic may include multiple flows that arrive at a UE (or a base station) concurrently with one another (or within a threshold period of time). For instance, the diagram 900 includes a second XR flow 908. The second XR flow 908 may have different characteristics than the first XR flow 902. For instance, the second XR flow 908 may have XR traffic bursts with different numbers of packets, different sizes of packets, etc. In an example, the first XR flow 902 may include video data and the second XR flow 908 may include audio data for the video data. In another example, the first XR flow 902 may include intra-coded picture frames (I-frames) that include complete images and the second XR flow 908 may include predicted picture frames (P-frames) that include changes from a previous image.

FIG. 9B is a diagram 950 illustrating an example of wireless communication between a user equipment (UE) 952, a base station 954, and a cloud server 956. In some aspects, the service provided to the UE 952 may be an XR service or a cloud gaming service, and the associated traffic may be associated with a low latency. As an example, th uplink (UL) packet 960 may include input information such as tracking information or user pose information for the XR service or inputs for the cloud gaming service. In some examples, the UL packet 960 may include data of 100 bytes every 2 ms (at 500 Hz). The cloud server 956 may receive the UL packet 960 and generate the downlink (DL) packet 962 based on the received UL packet 960. For example, the cloud server 956 may receive the UL packet 960 including the tracking/pose information for the XR service or inputs for the cloud gaming service, and generate the DL packet 962 based on the received UL packet 960 including the tracking/pose information for the XR service or inputs for the cloud gaming service.

The DL packet 962 may include an encoded data associated with the service provided to the UE. For example, the encoded data may include data of over 100 kilobytes at 45, 60, 75, or 90 frames per second (fps), i.e., every 22, 16, 13, or 11 milliseconds. The XR service or the cloud gaming service may be provided from a cloud server, and the DL packet 962 may include a quasi-periodic encoded video with burst frame every 1/fps seconds or two, possibly staggered, “eye-buffers” (or images) per frame every ½*fps seconds. In an example in which the UE is provided with the cloud gaming service, the DL packet 412 may include a quasi-periodic encoded video with burst frame every 1/fps seconds. In an example in which the UE is provided with the XR service, the DL packet 962 may include a quasi-periodic encoded video with separate images, staggered or simultaneously, for each eye per frame every ½*fps seconds. In some aspects, the latency observed from the UE 952 may be associated with a round-trip time (RTT) between transmitting the UL packet 960 and receiving the DL packet 962. That is, the network latency experienced at the UE 952 may be determined based on a RTT between transmitting the UL packet 960 including the tracking/pose information for the XR service or the inputs for the cloud gaming service and receiving the DL packet including the encoded data associated with the service provided to the UE 952.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising identifying a first remaining time of a first discard timer associated with a first delay budget for at least a first PDU that falls below a threshold for an associated first LCH; adjusting an LCH priority for the at least the first PDU in response to the remaining time falling below the threshold based at least on a second remaining time of a second discard timer associated with a second delay budget of a target LCH having a next higher priority than the first LCH; and transmitting an uplink transmission based on an adjusted LCH priority for the at least the first PDU.

Aspect 2 is the method of aspect 1, further includes that the threshold is configured via RRC signaling for the first LCH, wherein the first LCH is configured with a dynamic priority.

Aspect 3 is the method of any of aspects 1 and 2, further including comparing the second remaining time of the second discard timer for the target LCH and the first remaining time of the first discard timer for the first LCH.

Aspect 4 is the method of any of aspects 1-3, further includes that the LCH priority for at least the first PDU is not adjusted in response to the first remaining time of the first discard timer for the first LCH is greater than the second remaining time of the second discard timer for the target LCH.

Aspect 5 is the method of any of aspects 1-4, further includes that the LCH priority for at least the first PDU is adjusted in response to the first remaining time of the first discard timer for the first LCH is greater than a shortest remaining time of the second discard timer of the target LCH.

Aspect 6 is the method of any of aspects 1-5, further includes that the LCH priority for at least the first PDU is adjusted to the priority of the target LCH.

Aspect 7 is the method of any of aspects 1-6, further including receiving a priority configuration indicating a range of adjustment for the LCH priority.

Aspect 8 is the method of any of aspects 1-7, further including transmitting a capability indication indicating a first amount of LCHs that are configured with a dynamic priority or a second amount of target LCHs to which the LCH can upgrade.

Aspect 9 is an apparatus for wireless communication at a UE including at least one processor coupled to a memory and at least one transceiver, the at least one processor configured to implement any of aspects 1-8.

Aspect 10 is an apparatus for wireless communication at a UE including means for implementing any of aspects 1-8.

Aspect 11 is a computer-readable medium storing computer executable code, where the code when executed by a processor causes the processor to implement any of aspects 1-8.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to cause the apparatus to:
identify a first remaining time of a first discard timer associated with a first delay budget for at least a first protocol data unit (PDU) that falls below a threshold for an associated first logical channel (LCH);
adjust an LCH priority for the at least the first PDU in response to the remaining time falling below the threshold based at least on a second remaining time of a second discard timer associated with a second delay budget of a target LCH having a next higher priority than the first LCH; and
transmit an uplink transmission based on an adjusted LCH priority for the at least the first PDU.

2. The apparatus of claim 1, further comprising a transceiver coupled to the at least one processor, the transceiver being configured to:
transmit the uplink transmission based on the adjusted LCH priority for the at least the first PDU.

3. The apparatus of claim 1, wherein the threshold is configured via radio resource control (RRC) signaling for the first LCH, wherein the first LCH is configured with a dynamic priority.

4. The apparatus of claim 1, wherein to adjust the LCH priority, the at least one processor is configured to:
compare the second remaining time of the second discard timer for the target LCH and the first remaining time of the first discard timer for the first LCH.

5. The apparatus of claim 4, wherein the LCH priority for at least the first PDU is not adjusted in response to the first remaining time of the first discard timer for the first LCH is greater than the second remaining time of the second discard timer for the target LCH.

6. The apparatus of claim 4, wherein the LCH priority for at least the first PDU is adjusted in response to the first remaining time of the first discard timer for the first LCH is greater than a shortest remaining time of the second discard timer of the target LCH.

7. The apparatus of claim 6, wherein the LCH priority for at least the first PDU is adjusted to the priority of the target LCH.

8. The apparatus of claim 1, wherein the at least one processor is further configured to:
receive a priority configuration indicating a range of adjustment for the LCH priority.

9. The apparatus of claim 1, wherein the at least one processor is further configured to:
transmit a capability indication indicating a first amount of LCHs that are configured with a dynamic priority or a second amount of target LCHs to which the LCH can upgrade.

10. A method of wireless communication at a user equipment (UE), comprising:
identifying a first remaining time of a first discard timer associated with a first delay budget for at least a first protocol data unit (PDU) that falls below a threshold for an associated first logical channel (LCH);
adjusting an LCH priority for the at least the first PDU in response to the remaining time falling below the threshold based at least on a second remaining time of a second discard timer associated with a second delay budget of a target LCH having a next higher priority than the first LCH; and
transmitting an uplink transmission based on an adjusted LCH priority for the at least the first PDU.

11. The method of claim 10, wherein the threshold is configured via radio resource control (RRC) signaling for the first LCH, wherein the first LCH is configured with a dynamic priority.

12. The method of claim 10, wherein the adjusting the LCH priority further comprising:
comparing the second remaining time of the second discard timer for the target LCH and the first remaining time of the first discard timer for the first LCH.

13. The method of claim 12, wherein the LCH priority for at least the first PDU is not adjusted in response to the first remaining time of the first discard timer for the first LCH is greater than the second remaining time of the second discard timer for the target LCH.

14. The method of claim 12, wherein the LCH priority for at least the first PDU is adjusted in response to the first remaining time of the first discard timer for the first LCH is greater than a shortest remaining time of the second discard timer of the target LCH.

15. The method of claim 14, wherein the LCH priority for at least the first PDU is adjusted to the priority of the target LCH.

16. The method of claim 10, further comprising:
receiving a priority configuration indicating a range of adjustment for the LCH priority.

17. The method of claim 10, further comprising:
transmitting a capability indication indicating a first amount of LCHs that are configured with a dynamic priority or a second amount of target LCHs to which an LCH can upgrade.

18. A computer-readable medium storing computer executable code at a user equipment (UE), the code when executed by at least one processor causes the at least one processor to:
identify a first remaining time of a first discard timer associated with a first delay budget for at least a first protocol data unit (PDU) that falls below a threshold for an associated first logical channel (LCH);
adjust an LCH priority for the at least the first PDU in response to the remaining time falling below the threshold based at least on a second remaining time of a second discard timer associated with a second delay budget of a target LCH having a next higher priority than the first LCH; and
transmit an uplink transmission based on an adjusted LCH priority for the at least the first PDU.

19. The computer-readable medium of claim 18, wherein the threshold is configured via radio resource control (RRC) signaling for the first LCH, wherein the first LCH is configured with a dynamic priority.

20. The computer-readable medium of claim 18, wherein to adjust the LCH priority, the code when executed by the at least one processor causes the at least one processor to:
compare the second remaining time of the second discard timer for the target LCH and the first remaining time of the first discard timer for the first LCH.
